(19) United States
(12) Patent Application Publication
(10) Pub. No.: US 2012/0050900 A1
(43) Pub. Date: Mar. 1, 2012

(54) TRAILER HITCH MIRROR

(75) Inventors: Dennis Howard Heling, Lansing, MI (US); Glen Clark Allan, Dearborn Heights, MI (US)

(73) Assignee: GSD DIVERSIFIED, LLC, Dearborn Heights, MI (US)

(21) Appl. No.: 13/214,212

(22) Filed: Aug. 21, 2011

Related U.S. Application Data
(60) Provisional application No. 61/378,935, filed on Sep. 1, 2010.

(51) Int. Cl. B60R 1/078

(52) U.S. Cl. 359/872; 359/871

(57) ABSTRACT

A device aids the visual alignment of a ball on a hitch at the rear of a towing vehicle to a ball receiving socket on a tongue of a trailer. The device has a one-piece elongated member. The elongated member has a first end with a first flattened portion adjacent thereto and a second end with a second flattened portion adjacent thereto. The elongated member has a bend therein located between the two flattened portions. Two suction cups are attached to the first flattened portion of the elongated member. A mirror is attached to the second flattened portion of the elongated member. In a preferred embodiment each of the suction cups is associated with a stabilizer member.

### IDENTIFICATION OF RELATED APPLICATIONS

This application claims the benefit of U.S. Provisional Application Ser. No. 61/378,935 filed on 1 Sep. 2010, the disclosure of which is fully incorporated herein by reference.

### FIELD OF THE INVENTION

The present invention relates to a trailer hitch mirror that aids a driver of a tow vehicle to align and couple the tow ball of the towing vehicle and the socket of a trailer coupler by enabling the driver of the tow vehicle to view the tow ball and a trailer coupler while in the driver's seat of the tow vehicle.

### BACKGROUND OF THE INVENTION

Connecting a trailer to a towing vehicle is a difficult task when performed by one person. The difficulty arises from the need to position the tow ball of the towing vehicle under the socket of the trailer coupler. Typically, when a lone person backs a towing vehicle toward a trailer neither the tow ball nor the trailer coupler is visible while he or she is in the driver's seat of the towing vehicle. Therefore, he or she must maneuver the vehicle back and forth numerous times, getting out of the vehicle each time to check on the positioning of the tow ball and trailer coupler socket until he or she has positioned the tow ball just beneath the trailer coupler socket. There have been numerous attempts to provide mirrors that can enable the driver to see the tow ball and trailer coupler as he or she backs up to facilitate alignment of the trailer coupler with the tow ball. However, a need still exists for an easily mountable and removable trailer hitch mirror that can be used with a variety of vehicle body types and is affordable.

### DISCUSSION OF THE PRIOR ART

One approach to solving the problem of viewing a trailer hitch while operating a motor vehicle is to mount a mirror on a vehicle using mechanical fasteners or hanging arrangements as disclosed for example in: U.S. Pat. No. 5,180,182; U.S. Pat. No. 5,482,310; U.S. Pat. No. 5,657,175; U.S. Pat. No. 6,446,999 B1; U.S. Pat. No. 6,955,437 B1; and U.S. D508,883 S.

Another approach to solving the problem of viewing a trailer hitch while operating a motor vehicle is to mount a mirror on the trailer as disclosed for example in: U.S. Pat. No. 3,767,292; U.S. Pat. No. 4,163,606; U.S. Pat. No. 5,235,468; U.S. Pat. No. 5,309,289; U.S. Pat. No. 6,076,847; U.S. Pat. No. 6,239,926 B1; U.S. Pat. No. 6,499,851 B1; U.S. Pat. No. 6,923,463 B1; and U.S. Pat. No. 7,216,885 B1.

Another approach to solving the problem of viewing a trailer hitch while operating a motor vehicle is to mount a mirror on a vehicle using at least one magnet as disclosed for example in: U.S. Pat. No. 5,478,101 and U.S. Pat. No. 7,621,555 B2.

Another approach to solving the problem of viewing a trailer hitch while operating a motor vehicle is to mount a mirror on a vehicle using at least one suction cup. U.S. Pat. No. 4,624,539; U.S. Pat. No. 5,825,564 and U.S. Pat. No. 5,625,500 disclose trailer hitch mirrors that are mounted to a vehicle using only one suction cup and have a mirror support structure comprising several pieces. U.S. Pat. No. 4,925,287; U.S. Pat. No. 5,111,342; U.S. Pat. No. 5,784,213; U.S. Pat. No. 6,102,423; U.S. Pat. No. 6,130,790; U.S. Pat. No. 6,409,200 B1; and U.S. Pat. No. 6,422,585 B1 disclose trailer hitch mirrors that are mounted to a vehicle using two suction cups and have a mirror support structure comprising several pieces. U.S. Pat. No. 6,619,685 B2 and U.S. Pat. No. 6,880,849 B2 disclose trailer hitch mirrors that are mounted to a vehicle using either one suction cup or two suction cups and have a mirror support structure comprising several pieces. U.S. Pat. No. 5,971,555 and U.S. Pat. No. 6,062,697 disclose trailer hitch mirrors that are mounted to a vehicle using three suction cups and have a mirror support structure comprising several pieces. U.S. Pat. No. 5,313,337 and U.S. Pat. No. 6,932,374 B1 disclose trailer hitch mirrors that are mounted to a vehicle using four suction cups.

Many of the prior art trailer hitch mirrors have utility with only a single type of vehicle body, and have relatively complex mirror support structures that in some cases can be adjusted for use with more than one type of vehicle body or even different models of vehicles of a particular body type. A trailer hitch mirror of the present invention is mounted to a vehicle using two suction cups, but differs from all of the prior art trailer hitch mirrors by having a mirror support that comprises only a single piece that is bent to have curves that facilitate the use of the trailer hitch mirror with a variety of vehicle body types.

### SUMMARY OF THE INVENTION

A device aids the visual alignment of a ball on a hitch at the rear of a towing vehicle to a ball receiving socket on a tongue of a trailer. The device has a rigid one-piece elongated member. The elongated member has a first end with a first flattened portion adjacent thereto and a second end with a second flattened portion adjacent thereto. The elongated member has a bend therein located between the two flattened portions. Two suction cups are attached to the first flattened portion of the elongated member. A mirror is attached to the second flattened portion of the elongated member. In a preferred embodiment each of the suction cups is associated with a stabilizer member.

### BRIEF DESCRIPTION OF THE DRAWINGS

FIG. 1 is a perspective view of a first embodiment of a trailer hitch mirror.

FIG. 2 is a first perspective view of a second embodiment of a trailer hitch mirror.

FIG. 2A is a cross section taken at line A-A of FIG. 2.

FIG. 2B is a cross section taken at line B-B of FIG. 2.

FIG. 3 is a second perspective view of the trailer hitch mirror of FIG. 2.

FIG. 4 is a third perspective view of the trailer hitch mirror of FIG. 2.

FIG. 5 shows a trailer hitch mirror of the present invention fixed to a trunk lid of a sedan.

FIG. 6 shows a trailer hitch mirror of the present invention fixed to a tailgate of a pickup truck.

FIG. 7 shows a trailer hitch mirror of the present invention fixed to a rear window of a van.

### DETAILED DESCRIPTION OF THE INVENTION

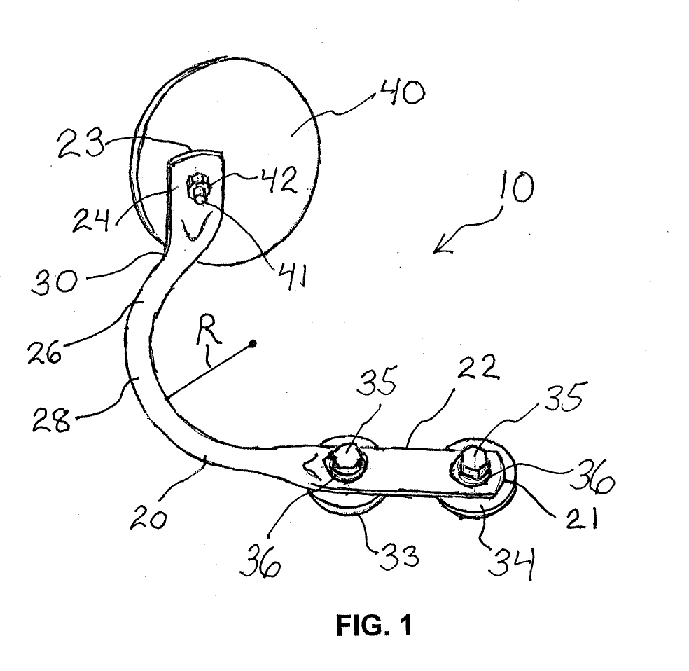

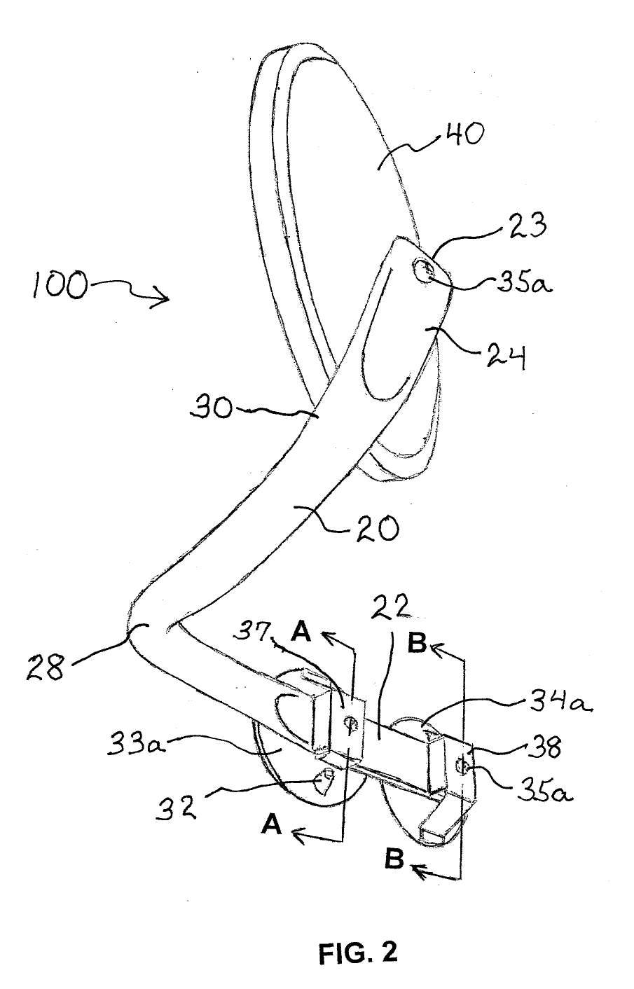

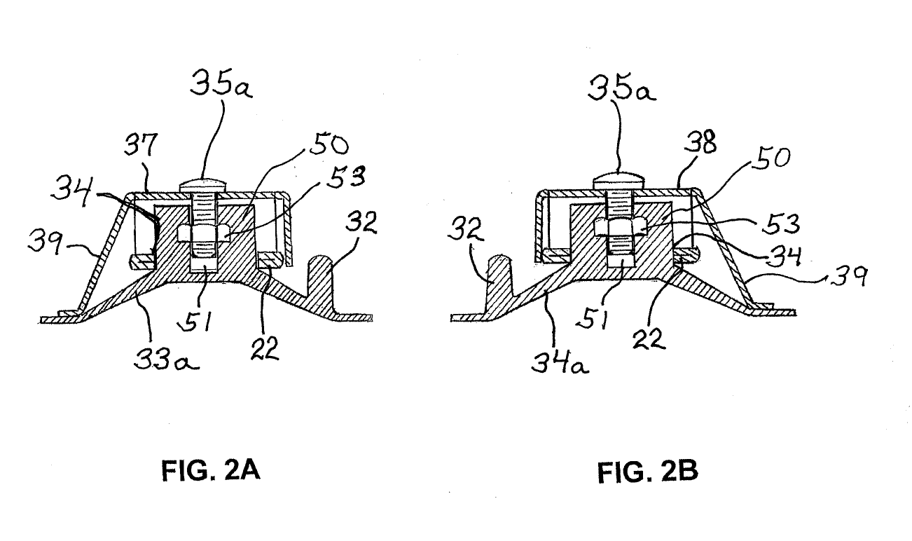

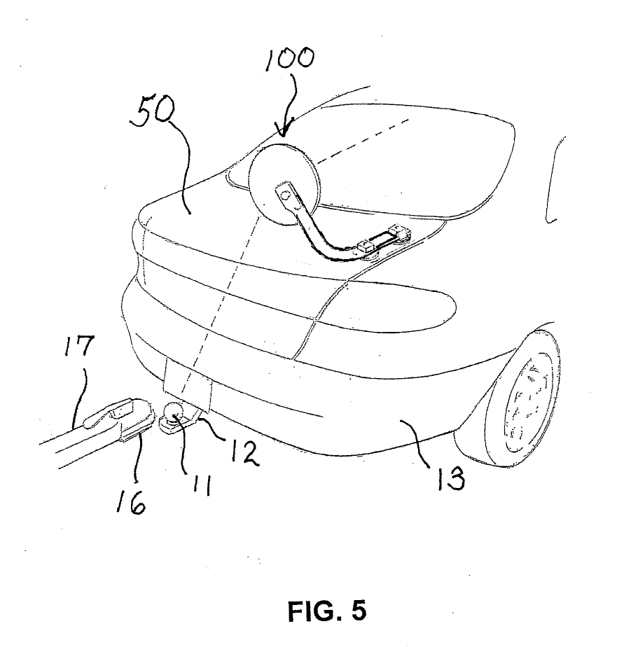

FIG. 1 shows a first embodiment of a trailer hitch mirror 10 of the present invention, and FIGS. 2-4 show a second embodiment of a trailer hitch mirror 100 of the present invention. Most components are common to both embodiments, and these components are identified with the same reference characters in the drawings of both embodiments. FIGS. 5-7 show a trailer hitch mirror 100 of the present invention mounted in operative positions on various types of vehicles.

A trailer hitch mirror 10, 100 of the present invention is device for aiding the visual alignment of a ball 11 on a hitch 12 at the rear of a towing vehicle 13, 14, 15 to a ball receiving socket 16 on a tongue 17 of a trailer by an operator of the towing vehicle occupying the driver's seat of the vehicle. Typical known prior art trailer hitch mirrors have three basic components: a means for attaching the trailer hitch mirror to a vehicle or trailer; a mirror supporting component that usually involves several pieces; and a mirror fixed to the mirror supporting component. With reference to FIGS. 1-4 a device 10,100 of the present invention has a rigid one-piece elongated member 20 to which both a means of attaching the trailer hitch mirror to a vehicle and a mirror are attached. As used herein and in the claims the term “rigid”” is understood to have its ordinary meaning of “incapable of or resistant to bending”. As used herein and in the claims the term “one-piece” is understood to have its ordinary meaning of “consisting of or fashioned in a single piece or part”. As used herein and in the claims the term “elongated” is understood to have its ordinary meaning of “having notably more length than width; being long and slender”.

The one-piece elongated member 20 has a first end 21 with a first flattened portion 22 adjacent thereto and a second end 23 with a second flattened portion 24 adjacent thereto. An intermediate portion 26 extends between the first and second flattened portions 22, 24. The one-piece elongated member may be tubular with the tubular structure being worked at its ends to form the first and second flattened portions. In such an embodiment the starting piece may simply be a metal or polymeric tube of any suitable material. It is understood that the one-piece elongated member may be molded, for example of a suitable polymeric material. The intermediate portion 26 of the elongated member 20 has a first bend 28 located therein. The first bend 28 has a radius of curvature R of about six inches. A second bend 30 is located at the junction of the second flattened portion 24 and the intermediate portion 26. The second bend is about fifty-five degrees.

Two suction cups 33, 34; 33a, 34a are attached to the first flattened portion 22 of the elongated member. A distinction of the suction cups 33a, 34a of FIGS. 2-4 from the suction cups 33, 34 of FIG. 1 is that the suction cups 33a, 34a are provided with a protruding member 32 that can be pushed upon to distort a suction cup and break the seal of the suction cup to an underlying surface. The suction cups 33, 34; 33a, 34a may be attached to the first flattened portion of the elongated member by any suitable securing means including for example an adhesive, or a clamping arrangement. As best shown in FIGS. 2A and 2B, in both embodiments the first flattened portion has a pair of passages 34 therethrough. In both embodiments each of the suction cups has a protruding portion 50 that defines a well 51. A threaded member 53 provided with internal threads, such as a nut, is molded into the suction cup with the internal threads of the threaded member located in the well of the protruding portion of the suction cup. The protruding portion 50 of a suction cup extends at least into, and if desired through, one of the passages 34 through the first flattened portion. As shown in FIG. 1 a hex head screw 35 provided with external threads that are complementary to the internal threads of the threaded member extends through a washer 36 into the well in the protruding portion of the suction cup and mates with the threaded member such that the flattened portion 22 of the elongated member is located between the suction cup 33, 34 and the washer 36 and the head of the hex head screw 35. Alternatively as shown in the second embodiment 100 illustrated in FIGS. 2-4 a flat head screw 35a having threads that are complementary to the internal threads of the threaded member 53 passes through a stabilizing member 37, 38 such that the flattened portion 22 of the elongated member is located between the suction cup 33a, 34a and the stabilizing member and the head of the flat head screw 35a.

A significant distinction between the first and second disclosed embodiments 10, 100 is that in the second, and preferred embodiment 100 of FIGS. 2-4, a stabilizing member 37, 38 is interposed between the securing means 35a and the flattened portion 22 of the elongated member 20. The stabilizing members may be made of a plastic, or a metal, or any other suitable material. As shown each stabilizing member generally has the shape of an inverted box, but any suitable shape may be employed. Each stabilizing member 37, 38 has an extension 39 that extends towards a surface of the associated suction cup 33a, 34a to limit movement of the rigid elongated member 20 with respect to the suction cup. As best seen in FIGS. 2, 2A and 2B the extension 39 of the stabilizing member 37, 38 associated with each suction cup extends in an opposite direction from the extension of the other stabilizing member. Thus, the extension of the stabilizing members restrict movement of the rigid elongated member to either side with respect to the suction cups when a vehicle 13, 14, 15 upon which a trailer mirror 100 of the present invention is mounted as shown in FIGS. 5-7.

A mirror 40 is attached to the second flattened portion 24 of the rigid elongated member 20. The mirror may be attached to the second flattened portion 24 of the elongated member by any suitable means including for example an adhesive, or a clamping arrangement. As shown in the drawings the second flattened portion has a passageway therethrough and a mirror is attached to the second flattened portion by a means for fastening, such as a stud 41, that extends through the passage through the second flattened portion. A stud 41 may be provided with external threads as shown in the embodiment 10 in FIG. 1 and a nut 42 or other securing means is fixed to the stud with the second flattened portion of the elongated member located between the mirror and the securing means. Alternatively as shown in the second embodiment 100 illustrated in FIGS. 2-4 the stud 41a may be provided with internal threads and the securing means may be a screw 35a having threads that are complementary to the internal threads of the stud. It is understood that a trailer hitch mirror of the present invention according to either embodiment may use either of these methods, or a combination thereof, for mounting the mirror to the rigid one-piece elongated member 20. It is further understood that the stud may not be provided with any threads and that the securing means may comprise a press fit member or a welded member or even an adhesively secured member. The mirror may be attached to the second flattened portion in a manner that allows the mirror to turn on a pivot.

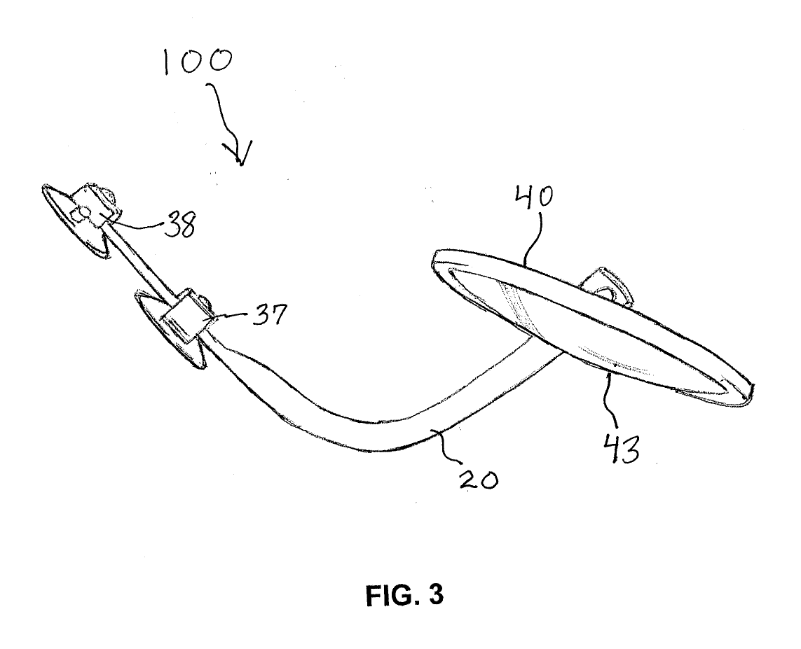

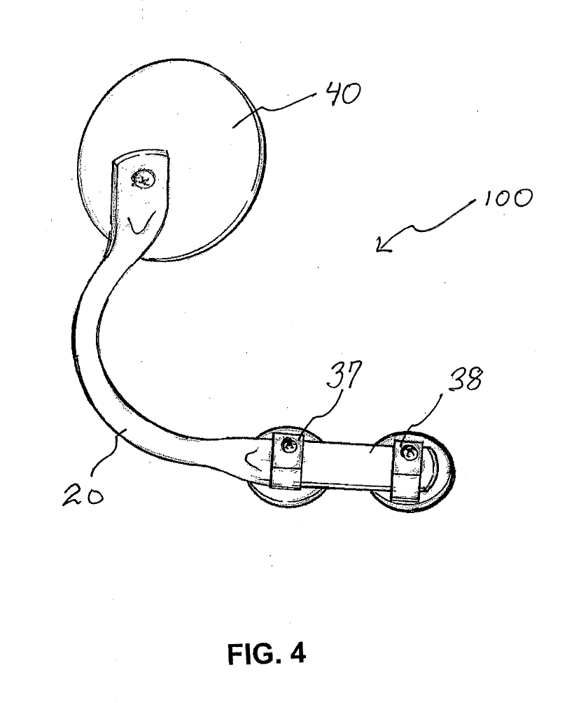

Preferably the mirror 40 has a convex reflective surface 43 that is reflective, as best shown in FIG. 3. As shown in the drawings the mirror is a circular mirror having a convex reflective surface and the attachment of the mirror to the one-piece elongated member is not at the center of the mirror as best shown in FIG. 4. This positioning of the mirror has been found facilitate the use of the device with a significant number of vehicle body types. It is understood that the mirror may have any suitable shape other than round, such as oval or rectangular.

FIG. 5 shows a trailer hitch mirror 100 of the present invention fixed to the trunk lid 50 of a sedan 13 by the two suction cups that are attached to the first flattened portion of the elongated member. The dashed lines in this figure indicate the line of sight that a person seated in the driver's seat of the sedan has of the hitch 12 at the rear of a towing vehicle and a ball receiving socket on a tongue 17 of a trailer. The most advantageous positioning and configuration of the trailer hitch mirror of the present invention for any vehicle is achieved through the placement of the suction cups on the vehicle and the orientation of the mirror achieved by the pivoting the mirror. It is to be noted that the mirror does not need to be located at the longitudinal centerline of the vehicle to be operative, but the best positioning of the mirror is to be determined for an individual vehicle operator for any particular vehicle.

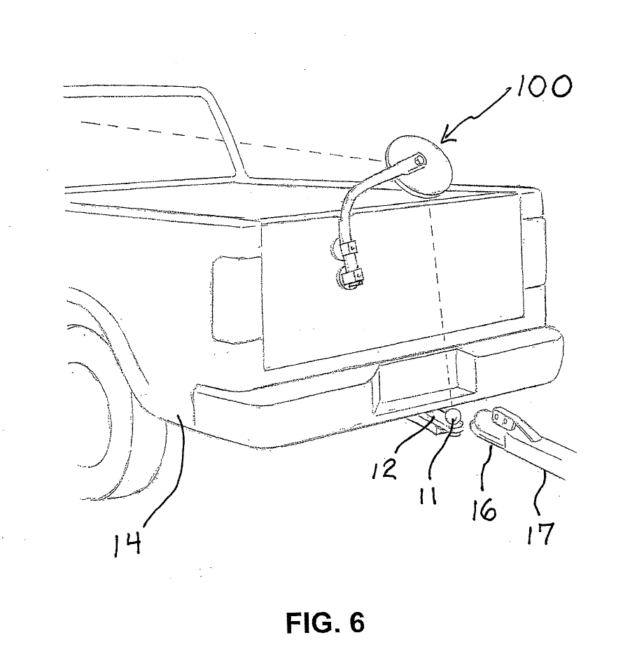

FIG. 6 shows a trailer hitch mirror 100 of the present invention fixed to the tailgate 51 of a pickup truck 14 by the two suction cups that are attached to the first flattened portion of the elongated member. The dashed lines in this figure indicate the line of sight that a person seated in the driver's seat of the pickup truck has of the hitch 12 at the rear of a towing vehicle and the ball receiving socket on a tongue 17 of a trailer. The most advantageous positioning and configuration of the trailer hitch mirror of the present invention for any vehicle is achieved through the placement of the suction cups on the vehicle and the orientation of the mirror achieved by the pivoting the mirror. The versatility of the trailer hitch mirror of the present invention is evidenced by the very different orientation of the same device on the sedan and the pickup truck to achieve the desired view of the hitch at the rear of a towing vehicle and a ball receiving socket on a tongue of a trailer.

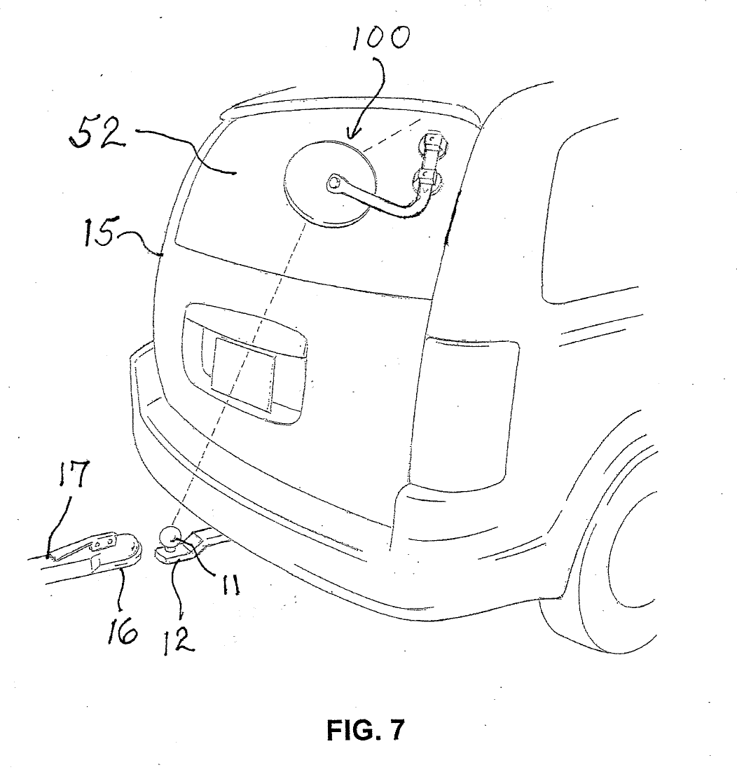

FIG. 7 shows a trailer hitch mirror 100 of the present invention fixed to the rear window 52 of a van 15. The dashed lines in this figure indicate the line of sight that a person seated in the driver's seat of the van has of the hitch 12 at the rear of a towing vehicle and the ball receiving socket on a tongue 17 of a trailer. The most advantageous positioning and configuration of the trailer hitch mirror of the present invention for any vehicle is achieved through the placement of the suction cups on the vehicle and the orientation of the mirror achieved by the pivoting the mirror. Again the versatility of the trailer hitch mirror of the present invention is evidenced by the very different orientation of the same device on the van, sedan and the pickup truck to achieve the desired view of the hitch at the rear of a towing vehicle and the ball receiving socket on a tongue of a trailer.

While the invention has been described with reference to certain exemplary embodiments, obvious modifications and alterations are possible by those skilled in the related art. Therefore, it is intended that the invention include all such modifications and alterations to the full extent that they come within the scope of the following claims or the equivalents thereof.

What is claimed is:

1. A device for aiding the visual alignment of a ball on a hitch at the rear of a towing vehicle to a ball receiving socket on a tongue of a trailer, the device comprising a rigid one-piece elongated member, the elongated member having a first end with a first flattened portion adjacent thereto and a second end with a second flattened portion adjacent thereto and an intermediate portion extending between the first and second flattened portions, the intermediate portion of the elongated member has a first bend located therein, a second bend is located at a junction of the second flattened portion and the intermediate portion, two suction cups are attached to the first flattened portion of the elongated member and a mirror is attached to the second flattened portion of the elongated member.

2. The device of claim 1 wherein the mirror has a convex reflective surface.

3. The device of claim 1 wherein the mirror is attached to the second flattened portion of the elongated member in a manner that allows the mirror to pivot.

4. The device of claim 3 wherein the mirror is attached to the second flattened portion of the elongated member in a manner that allows the mirror to pivot.

5. The device of claim 1 wherein the elongated member is tubular.

6. The device of claim 1 wherein the elongated member is solid.

7. The device of claim 1 wherein the mirror is a circular mirror having a convex reflective surface and the attachment of the mirror to the one-piece elongated member is not at the center of the mirror, and the mirror is attached to the second flattened portion of the elongated member in a manner that allows the mirror to pivot.

8. The device of claim 1 wherein each of the suction cups has a stabilizing member associated therewith.

9. A device for aiding the visual alignment of a ball on a hitch at the rear of a towing vehicle to a ball receiving socket on a tongue of a trailer, the device comprising a rigid one-piece elongated member, the elongated member having a first end with a first flattened portion adjacent thereto and a second end with a second flattened portion adjacent thereto and an intermediate portion extending between the first and second flattened portions, the intermediate portion of the elongated member has a first bend located therein, a second bend is located at a junction of the second flattened portion and the intermediate portion, the first flattened portion has a pair of passages therethrough, two suction cups are attached to the first flattened portion, each suction cup being attached to the first flattened portion with at least one of (a) a portion of the suction cup or (b) a means for fastening extending through one of the passages through the first flattened portion; the second flattened portion has a passageway therethrough and a mirror is attached to the second flattened portion by a means for fastening that extends through the passage through the second flattened portion.

10. The device of claim 9 wherein the mirror has a convex reflective surface and is attached to the second flattened portion of the elongated member in a manner that allows the mirror to pivot.

11. The device of claim 9 wherein the mirror is a circular mirror having a convex reflective surface and the attachment of the mirror to the one-piece elongated member is not at the center of the mirror and the mirror is attached to the second flattened portion of the elongated member in a manner that allows the mirror to pivot.

12. The device of claim 9 wherein each of the suction cups has a stabilizing member associated therewith, the stabilizing member being fixed to the device by the same means for fastening that fastens the suction cup to the device, wherein each stabilizing member has an extension that extends towards a surface of the suction cup to limit movement of the rigid elongated member with respect to the suction cup, the extension of the stabilizing member associated with each suction cup extending in an opposite direction from the extension of the other stabilizing member.

13. A device for aiding the visual alignment of a ball on a hitch at the rear of a towing vehicle to a ball receiving socket on a tongue of a trailer, the device comprising:
(a) a rigid one-piece elongated tubular member, the elongated tubular member having a first end with a first flattened portion adjacent thereto and a second end with a second flattened portion adjacent thereto and an intermediate portion extending between the first and second flattened portions, the intermediate portion of the elongated member has a first bend located therein, a second bend is located at a junction of the second flattened portion and the intermediate portion, the first flattened portion has a pair of passages therethrough, and the second flattened portion has a passageway therethrough;
(b) two suction cups are attached to the first flattened portion of the elongated member, each suction cup including a threaded member provided with internal threads, each suction cup being attached to the first flattened portion of the elongated member by a threaded fastener having external threads that are complementary to and mate with the internal threads of the threaded member of the suction cup, the threaded fastener extends through a passage in a stabilizing member with the first flattened portion of the elongated member located between the suction cup and the stabilizing member, each stabilizing member has an extension that extends towards a surface of the suction cup to limit movement of the rigid elongated member with respect to the suction cup, the extension of the stabilizing member associated with each suction cup extending in an opposite direction from the extension of the other stabilizing member; and
(c) a mirror having a convex reflective surface is attached to the second flattened portion the elongated member by a stud that is fixed to the mirror in a manner that allows the mirror to pivot and extends through the passage through the second flattened portion of the elongated member and a securing means is attached to the stud with the second flattened portion of the elongated member located between the mirror and the securing means.

14. The device of claim 13 wherein the mirror is a circular mirror and the attachment of the mirror to the one piece elongated member is not at the center of the mirror.

15. The device of claim 13 wherein the elongated member is tubular.

16. The device of claim 13 wherein the elongated member is solid.

17. The device of claim 13 wherein the first bend has a radius of curvature of about six inches and the second bend is about fifty-five degrees.

18. The device of claim 13 wherein the stud associated with the mirror is provided with external threads and the securing means is a nut provided with internal threads that are complementary to the external threads of the stud.

19. The device of claim 13 wherein the stud associated with the mirror is provided with internal threads and the securing means is a screw provided with external threads that are complementary to the internal threads of the stud.

20. The device of claim 13 wherein each of the suction cups is provided with a protruding member that can be pushed upon to distort a suction cup and break a seal of the suction cup to an underlying surface.
